(19) United States
(12) Patent Application Publication
(10) Pub. No.: US 2016/0110406 A1
(43) Pub. Date: Apr. 21, 2016

(54) VALIDATION OF DATA ACROSS MULTIPLE DATA STORES

(71) Applicant: Microsoft Technology Licensing, LLC, Redmond, WA (US)

(72) Inventors: Dana Zircher, Cambridge, MA (US); Alan Norbauer, Cambridge, MA (US); Sterling Crockett, Belmont, WA (US); Jeffrey Stix, Cambridge, MA (US); Danielle DeBlois, Merrimac, MA (US)

(73) Assignee: MICROSOFT TECHNOLOGY LICENSING, LLC, Redmond, WA (US)

(21) Appl. No.: 14/621,802

(22) Filed: Feb. 13, 2015

Related U.S. Application Data
(60) Provisional application No. 62/064,562, filed on Oct. 16, 2014.

(51) Int. Cl. G06F 17/30

(52) U.S. Cl. CPC G06F 17/30371; G06F 17/30589; G06F 17/30424

(57) ABSTRACT

Examples of the present disclosure describe validation of data on a client having a plurality of data stores. A data consistency component of the client queries a plurality of data stores of the client to identify a portion of data from each of the data stores. The data consistency component compares portions of data obtained from the plurality of data stores using stored knowledge data, maintained by the data consistency component. Based on the comparison of the portions of data, the data consistency component identifies if inconsistency exists across the plurality of data stores. Inconsistency identified for any of the plurality of data stores is reported.

### PRIORITY

This application claims the benefit of U.S. Provisional Application No. 62/064,562, filed on Oct. 16, 2014, which is hereby incorporated by reference in its entirety.

### BACKGROUND

In a network environment, data may be maintained on a server and separate copies of the data may be maintained on different clients or other storages on the network. Synchronization of data tends to break down when more than one data store is introduced to maintain data because management of a large amount of pairwise validations becomes both unmaintainable and unreliable. It is with respect to this general technical environment that the present application is directed.

### SUMMARY

Examples of the present disclosure describe validation of data on a client having a plurality of data stores. A data consistency component of the client queries a plurality of data stores of the client to identify a portion of data from each of the data stores. The data consistency component compares portions of data obtained from the plurality of data stores using stored knowledge data, maintained by the data consistency component. Based on the comparison of the portions of data, the data consistency component identifies if inconsistency exists across the plurality of data stores. Inconsistency identified for any of the plurality of data stores is reported.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Additional aspects, features, and/or advantages of examples will be set forth in part in the description which follows and, in part, will be apparent from the description, or may be learned by practice of the disclosure.

### BRIEF DESCRIPTION OF THE DRAWINGS

Non-limiting and non-exhaustive examples are described with reference to the following figures.

FIG. 1 illustrates an overview of an example system that may be used to validate data stored on local components of a network environment.

FIG. 2 illustrates an example local component that includes multiple data stores.

FIG. 3 illustrates an example method for validating data across multiple data stores.

FIG. 4A illustrates an example method for reporting validation issues.

FIG. 4B illustrates an example of a report generated with respect to validation results.

FIG. 5 is a block diagram illustrating an example of a computing device with which aspects of the present disclosure may be practiced.

FIGS. 6A and 6B are simplified block diagrams of a mobile computing device with which aspects of the present disclosure may be practiced.

FIG. 7 is a simplified block diagram of a distributed computing system in which aspects of the present disclosure may be practiced.

### DETAILED DESCRIPTION

The present disclosure describes systems and methods for increasing integrity and consistency when performing validation of data that persists across multiple data stores. One way to maintain synchronization between data stores is to perform a full enumeration of data on data stores. A full enumeration of data updates values for all data stored in a data store using a remote source such as a network server. However, when a full enumeration of data is performed, a large amount of network and input/output (I/O) resources may be tied up causing increased network bandwidth and latency issues among other problems. Examples of the present disclosure describe efficient ways of maintaining a quality replica of data without requiring a new full replica of data to be retrieved from another network component/storage or requiring that a full enumeration of data be performed on an entire data store. Additionally, among other features, the present disclosure enables detection of data inconsistencies before a user may become aware of such inconsistencies such as errors in files maintained on a user-operated client.

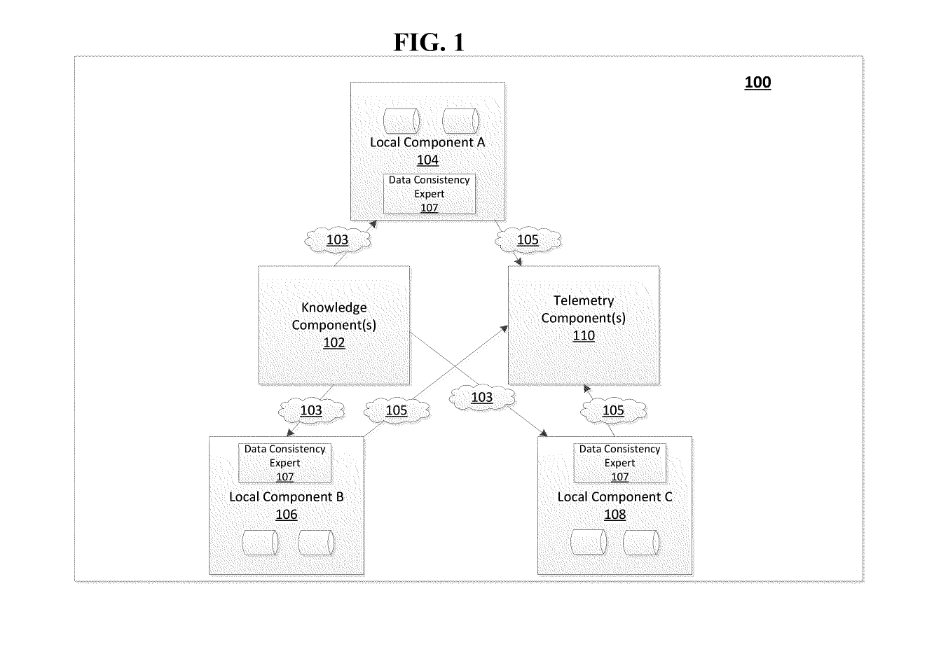

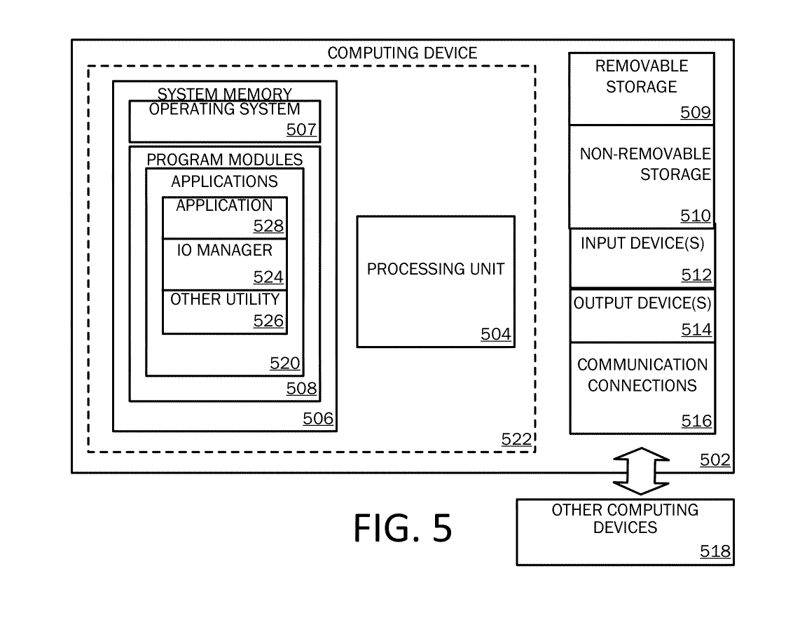

FIG. 1 illustrates an overview of an example system 100 that may be used to validate data stored on a local component in a network environment. The system 100 is a combination of interdependent components that interact to form an integrated whole. Components of the system 100 may be hardware components or software implemented on hardware components of the system 100. Individual components may connect with other components of the system 100 via a network. The network may be any configuration of data connections that allow components of the system 100 to pass data to and receive data from other components of the system 100. As an example, the system 100 may be a distributed environment that includes resources shared by more than one component such as a cloud-computing environment. Hardware components of the system 100 possess means for implementing a software process or program such as an application or service to run thereon. Please refer to FIGS. 5-7 for additional examples of hardware that may be included as part of the system 100. As one example, the system 100 may include components such as a knowledge component(s) 102, a local component A 104, local component B 106, local component C 108, and telemetry component(s) 110. However, the system 100 is not limited to such an example. The scale of systems such as system 100 may vary and include more or less components than those described in FIG. 1.

As an example, the system 100 may be used to run software components such as applications or services enabling clients or users to access and manage data. The system 100 may implement protocols or frameworks to oversee applications, services, processes, etc., running on a local component of the system 100 such as local component A, 104, local component B 106 or local component C 108. In one example, the system 100 may run a file hosting application or service, allowing clients or users to upload and sync files to a storage such as a distributed network (e.g., cloud storage). The file hosting application/service may allow clients to access files using an application (e.g. web browser) running on the local component such as a local device (e.g., mobile device, computer, laptop tablet or any device having a processor). File hosting applications/services may be associated with online services and allow users to keep files private, share them with contacts, or make files public. Examples of such filing hosting applications/services may be iterations of any distributed storage solution including Google Drive, iCloud, IBM SmartCloud, Dropbox, SugarSync, Syncplicity, OwnDrive, OneDrive, SkyDrive, Windows Live SkyDrive, and Windows Live Folders, among other examples. Other types of applications or services related to data synchronization may also be applicable.

System 100 may include a knowledge component 102 or data repository that may be used to store data for a network (e.g., a distributed computing environment such as a cloud-based environment). The knowledge component 102 may be comprised of one or more processing devices, storages, or combination thereof. An exemplary knowledge component 102 may be a server or any network storage device that stores information that is distributable to local components to enable local components to perform validation of data stores/data stored locally on a local component. As an example, information stored and distributed by the knowledge component 102 may include data identifying components of the system 100, definitions data for components of the system 100, policy rules for executing validations and any other information or data relevant to enable a local component of the system 100 to manage validation of its own components. As an example, the knowledge component 102 may store a master list of all files maintained by the system 100, for example in a normalized form. The knowledge component 102 may transfer information to a local component to assist a local component in management data. In one example, a local component may de-normalize data across multiple data stores. The knowledge component 102 may transmit information to aid a local component in managing its de-normalized data. Moreover, the knowledge component 102 interfaces with local components of the system 100, such as local component A 104, local component B 106, and local component C 108, to provide a local component with information usable in performing validation.

The local components illustrated in FIG. 1 interface with the knowledge component 102. A local component may be a hardware component such as a device having a processor (e.g., computer, desktop, laptop, tablet, mobile phone, etc.) or software component such as an application, module or virtual machine running on a processing device. As an example, a local component may be a client that manages file data locally and communicates with the knowledge component 102 and the telemetry component 110. As identified above, components of the system 100 may be connected through a network. Communication lines labeled 103 in FIG. 1 represent a networking communication between the knowledge component 102 and an individual local component. As an example, a local component (e.g., local component A 104) may receive a transmission of information from the knowledge component 102. Such information may be useful in assisting a local component with performance of a validation of validatable components of a local component. A validatable component may be any data or portion of the local component that is able to be checked for inconsistencies. As an example, a validatable component may include more than one aspect that can be evaluated to determine whether an inconsistency is present. For instance, in an example where a file directory component is being checked for consistency, a portion of data related to a validatable component may be evaluated across data stores of the local component. Multiple data stores may be associated with a local component. In that example, pairwise relationships may exist between data stores of the local component however validation issues may arise when it comes to validating data for a validatable component across multiple data stores. To address this issue, a local component may maintain knowledge data that is used in performing validation. Knowledge data may be any data usable for performing validation on validatable components or portions of a local component. In an example where a local component maintains more than one data store, knowledge data may identify relationships between data maintained by each of the data stores of a local component. In one example, a local component may initiate a communication with the knowledge component 102 such as requesting an update of knowledge data to manage validation of data stores of a local component.

A data store of a local component may be a subsystem of file data including files and folders of information. Examples of data stored by an individual data store of the local component may include but are not limited to the following types of data: validation data, metadata, a store for metadata about files on the file system, folder description information, and operating system data, among other examples. As identified above, a local component may comprise a plurality of data stores. Data stores may store or maintain different data (e.g., different types/forms). In one example, a data store of a local component may store files data for files maintained on a network server that may be a component of system 100 and another data store may store data for files persisted to disk. Knowledge data may be maintained by the local component to identify relationships between such data and enable validation to be performed across the different data stores. Other examples of data that knowledge data is maintained for may include but are not limited to synchronization information and binary file information maintained by data stores of a local component.

Each local component may include a data consistency expert 107. A data consistency expert 107 is a component to locally manage synchronization of data stores of the local component. A data consistency expert 107 manages validation of components associated with multiple data stores of a local component. As an example, a data consistency expert 107 may be software running on a local component such as a processing device or client device. As an example, the data consistency expert 107 may mirror information stored on the knowledge component 102. In some cases, a data store that is part of a local component may not be able to stay up to date with respect to transactions that occur on each of the data stores of the local component or other local components. As such, the data stores may have difficulty coordinating with each other and consistency of data replicated across data stores may be lost. The data consistency expert 107 is an example of a central authority on the local component that is used to maintain synchronization of data stored on a local component(s). As one example, the data consistency expert 107 enables the system 100 with many data stores to identify inconsistencies between data stores that may be unknown to individual data stores. The data consistency expert 107 may further identify files having inconsistencies that can result in errors that may negatively affect an end user experience, if the inconsistencies are not addressed. In yet another example, the data consistency expert 107 enables a reporting of inconsistency data (e.g., a validation error) to the telemetry component 110 of the system 100. Further, the data consistency expert 107 enables external validation of data stores to enhance maintenance of data integrity amongst data stores.

As an example, the data consistency expert 107 may perform validation of components of a local component or local components. As an example, the data consistency expert 107 may include a validator that manages validation/validations for a local component. In one example, the validator may define a schedule to ensure that validation of components occurs on a consistent basis. The validator may receive, compile, evaluate, and utilize knowledge data transmitted from the knowledge component 102 to identify all types of components that are able to be validated on a local component. In one example, the validator of the data consistency expert 107 may set and execute individual validation tasks, each of which evaluates validatable components to determine whether an inconsistency is present among data stores of a local component. In that example, validation of components may occur in one or more tasks. When the validator determines that a validation is to be performed, the validator may take as an input, an array of one or more validatable components and may perform validation each of each validatable component. Validation of components may occur at the same time. However, in other examples, validation of components may occur at different times. The validator of the data consistency expert 107 may use a smart heuristic to improve scheduling of evaluating of validatable components. A smart heuristic may be any component (hardware or software) of the data consistency expert 107 that is capable of analyzing data and making a decision to improve processing for the data consistency expert 107. In one example, the validator may utilize the smart heuristic to determine optimal times to perform validation on components of a local component. In one instance, the smart heuristic may determine a time where performance of the system 100 is less utilized and thus, efficiency in scheduling can be achieved. In one example, the smart heuristic may identify times where processing resources of a local component have greater availability so that the validator can control performance of validation (e.g., start and stop) to accommodate for changes in processing. When a validation is completed, the data consistency expert 107 may store results of validations locally for use by a repair function or for local diagnostic use at a later date. The results for a validation are also communicated to a telemetry component 110 for evaluation.

The telemetry component 110 may receive data related to performance of a validation(s) from any local component of the system 100 such as local component A 104, local component B 106 or local component C 108. Communication lines labeled 105 in FIG. 1 represent a networking communication in the system 100 between a local component (e.g., local component B 106) and the telemetry component 110. The telemetry component 110 may be a component of the system 100 that performs, collects, evaluates and/or monitors data and or performance of validations by local components. In one example, the telemetry component 110 may receive, collect, compile, evaluate, monitor and report data in an automated process. As an example, the telemetry component may generate data that is helpful to an administrator or a product team, among other examples. The telemetry component 110 may also perform statistical analysis on data received from a local component or local components. In one example, the telemetry component 110 may aggregate validation results and generate reports for viewing. This may enable an administrator to more quickly identify issues and proactively perform updates to the system 100 to minimize errors that might manifest to be identifiable by an end user and/or perform preemptive error corrections to prevent degradation of a user performance. Data may be aggregated for one or more local components, and generated in a report format using the telemetry component 110.

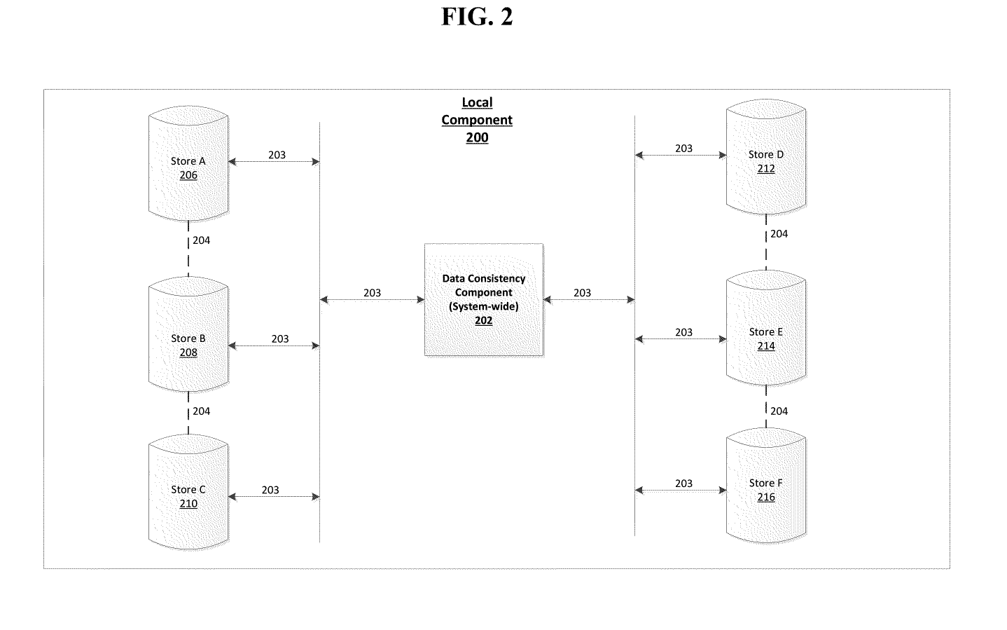

FIG. 2 illustrates an example of a local component 200 that includes multiple data stores. The local component 200 may be an example of local components described in FIG. 1, for example local component A 104, local component B 106 and local component C 108. The local component 200 may comprise a data consistency component 202 and multiple data stores, for example store A 206, store B 208, store C 210, store D 212, store E 214 and store F 216. Each data store of a local component 200 may be a subsystem of file data including files and folders of information. Examples of data stored by an individual data store of the local component may include but are not limited to the following types of data: validation data, metadata, folder description information, and operating system data, among other examples. The data consistency component 202 may be a system-wide central authority of a local component that is used to manage validation of data across the multiple data stores of the local component 200. In one example, the data consistency component 202 may provide functionality similar to the data consistency expert 107 described in FIG. 1. The data consistency component 202 provides for management of synchronization of data stored locally across storage A through storage F (FIGS. 2: 206, 208, 210, 212, 214 and 216, respectively). Data stores may attempt to maintain pairwise validation with at least another data store as shown by communication line 204. However, it may be difficult for data stores to maintain consistency with multiple other data stores where data is spread across a plurality of data stores. For example, data store A 206 may maintain a pairwise relationship with data store B 208 (e.g., communication line 204) but synchronization with stores C-F may present challenges. In one instance, the combination of the system-wide data consistency component 202 and stores A-F (FIGS. 2: 206, 208, 210, 212, 214 and 216, respectively) may resemble a hub—and spoke model where the data consistency expert 202 is a central authority for management of the plurality of data stores across the local component 200.

As an example, the data consistency component 202 may manage registry keys related to running of a task for validation of a component of the local component 200. Registry keys may be set for the following to control functionalities including but not limited to:
obtaining knowledge data to properly perform validation;
toggling validation on/off among validatable components;
controlling when to perform validation (e.g., before or after a synchronization event);
types of data to collect during validation (e.g., on a per task basis)
where to upload collected data;
parameters related to performance of validation (e.g., iterative process of performing a validation task, triggers that may signal to start or end a run, timing of run, exceptions, etc.);
support for interruptability of validation;
capturing/logging of results (e.g., detected inconsistencies/error entries or alternatively detection and logging of normal entries) and inconsistency correction; and
re-execution of failed validations (e.g., before or after remediation occurs).

As in examples describing a data consistency expert 107 of FIG. 1, a data consistency component 202 may comprise a validator to manage validation of components of the local component 200. A validatable component may be a portion or part of a local component that is able to be checked for inconsistencies. As an example, a validatable component may be a component whose responsibility is syncing data from a system component (e.g., a server) to the local component 200. As another example, a validatable component may be a component whose responsibility is monitoring changes in a file directory of a data store of the local component 200.

For example, validation of a component may include checking specific information managed by the validatable component with respect to a data store of the local component 200. Validation may include validating specific file identification information, pathways associated with data maintained by the data store (e.g., file/folder), modifications of data related to a data store, etc. As an example, validation of a single component may include performing a plurality of validation checks. A validation check uses one or more computational rules to determine if specific data related to the validatable component is valid. As data stores (or subsystems) may manage different data, validation may differ depending on a subsystem that is being validated. As an example, in a case where a validation component is related to synchronization of data, validation checks may differ compared with a validation relating to management of monitoring changes in a file directory. Validation rules, definitions, routines, etc., used to perform validation (including validation checks) may be managed and set by the data consistency component 202 and executed using the validator. The data consistency component 202 may manage knowledge data to enable performance of validation. As an example, knowledge data may include data identifying validatable components, definitions of validatable components, policy rules for executing validations and any other information or data relevant to enable a local component 200 to manage validation. Exemplary knowledge data may identify relationships between data stores (e.g., store A 206, store B 208, store C 210, store D 212, store E 214 and store F 216) of the local component 200. As an example, knowledge data may be used by the data consistency component 202 to match a portion or portions of data of a data store with a portion or portions of data of another data store. The data consistency component 202 may compare portions of data (e.g., tables, columns, lines, rows, etc.) obtained from the plurality of data stores using knowledge data to identify inconsistencies between data stores of a local component 200.

The validator of the data consistency component 202 may perform validation of components in order to identify existing or potential issues that may affect an experience of an end user of the local component 200. Performance of a validation may be pre-scheduled to execute (e.g., every 12 hours) or may be executed based on a request (e.g., received from an administrator or by a component of the local component 200). In one example, performance of validation may occur in one or more assigned tasks. A task run by the validator of the data consistency component 202 may perform validation of a validatable component related to a data store of the local component 200. In performing a validation, the validator may evaluate a data store as a whole, including file data maintained by a data store of the local component 200, to identify inconsistencies in the data store. In another example, the validator may compare portions of data across multiple data stores (e.g, store data stores (e.g., store A 206, store B 208, store C 210, store D 212, store E 214 and store F 216) of the local component 200, to determine inconsistencies among data stores. As data stores of the local component 200 may have different relationships, dimensions of relational aspects between data stores may be validated. For example, validations may be performed on data associations (e.g., one-one one-many, many-many) between data stores.

The data consistency component 202 may use results of validation performance to identify inconsistencies among data stores a local component 200. In some examples, a validatable component may initiate a request to execute a validation. In that example, the data consistency component 202 may receive a request from a component of a data store, and perform validation.

In one example, the data consistency component 202 may compare validatable components of one or more data stores of the local component 200 against data maintained by the data consistency component 202. In an example, validation may be iterated through some or all of the files of a data store and ensure that data such as metadata associated with a validatable component in each of the other stores matches data maintained by the data consistency component 202. In another example, the data consistency component 202 may obtain validatable components (e.g., files or data) from each of a plurality of data stores of the local component 200. The data consistency component 202 may perform validation on each validatable component including a comparison of a specific validatable component across each data store of the local component 200. For example, a portion of data may be received from store A 206. When the data consistency component 202 performs validation on the portion of data received from store A 206, the data consistency component 202 uses knowledge data to identify portions of data in other data stores of the local component 200 that relate to the portion of data received from store A 206. As an example, the portion of data for store A 206 may relate to rows of data 10-12 in a file maintained on store A 206 or a portion of metadata from file. The data consistency component 202 may use the knowledge data to determine that the data of store A 206 being validated corresponds to a portion of data (e.g., rows 13-15) of a file maintained in store D 212. Validation may be performed by comparing such portions of data for store A 206 and store D 212. Additionally, a comparison performed in the validation may be a comparison of many data stores. This enables the data consistency component 202 to identify when data stores of the local component 200 may be out of sync and what components of an overall system could be queuing changes that cause data stores to lose synchronization. As another example, a validation may comprise evaluating aspects of a file directory component, that manages a list of file changes occurring on a data store of the local component 200, by comparing state data for a file maintained by the data store with state data for data (e.g., file/folder) managed by the data consistency component 200 (e.g., the validator). State information may be any information that identifies a current state of data. The data consistency component 202 may further evaluate and compare state data of more than one data store associated with the local component 200.

When performing validation, the data consistency component 202 may request a data store of the local component 200 to provide any data that may be useful to validate a validatable component (e.g. metadata or file data) of all files in a subsystem (e.g., data store). As an example, data may be provided to the data consistency expert 202 by a data store of the local component 200 on a per library basis. Using a synchronization component as an example of a component that a validation is performed on, the data consistency component 202 may evaluate data received from a data store and compare the data store(s) to determine, among other things: 1) whether the data store(s) being compared have the same set of file data persisting thereon as a master file maintained by the data consistency component 202, and 2) do the files maintained on a data store correctly match the master files maintained by the data consistency component 202. Master file data maintained by the data consistency component 202 may be a set of data usable to maintain synchronization between data stores of the local component 200. As an example, the data consistency component 202 runs a task that some set of data stores in an overall system. An example task may be a task that compares files stores on a local operating system (OS) with other data stores of the local OS. In that exemplary task, relevant files are run through to ensure that the metadata in each of the data stores matches that of a file system. Continuing that exemplary task, the data stores may also be compared to ensure that the same files are represented in the data stores.

The data consistency component 202 may use a unique identifier (e.g., server file ID) or foreign key to identify files and folders of a data store for comparison. As an example of comparing whether file data matches that of the data consistency component 202, metadata about a file path may be evaluated. As end users may have modified files (e.g., changing a location of a file by moving it to another folder or renaming the file), it is likely that there may be a difference between file data stored in a particular data store and the master file data maintained by the data consistency component 202. Such differences can be determined, reported and corrected before a user experiences issues. Identifying specific validation components that cause issues affords a system or service an opportunity to specifically identify issues related to file data and implement efficient means to correct such file issues before the issues manifest to a user. For example, updates may be performed specifically for inconsistencies identified with respect to a validatable component including modification to specific data associated with the validatable component (such as metadata), without having to perform a full enumeration of data persisting on a data store. Additionally, a quality replica of data is able to be maintained locally without requiring a new replica of data to be retrieved from another network component/storage such a shared server when a validation inconsistency is detected. Thus, network resources can be efficiently managed so that a user doesn't have to experience issues when using a user interface, and the local component 200 is not required to tie up network resources to obtain updated file information if consistency is lost between data stores. Furthermore, data stores across the local component 200 may be efficiently updated using the system-wide data consistency component 202.

Moreover, the local component 200 may be configured to transmit validation results to a telemetry component such as the telemetry component 110 of FIG. 1. This enables administrators of a system to monitor and proactively address data synchronization issues for an application or service running on the system.

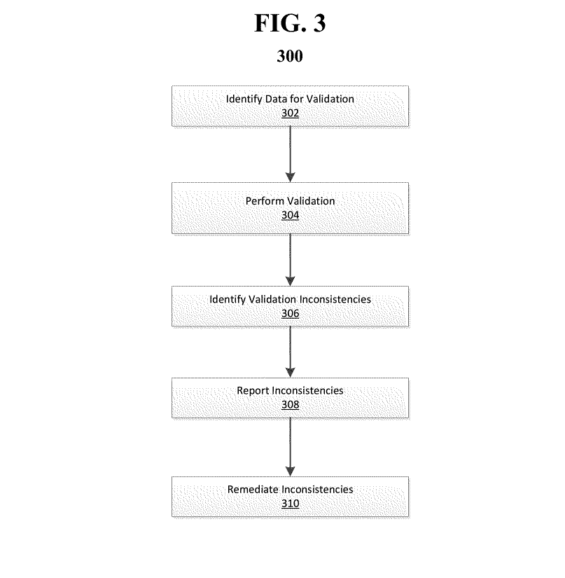

FIG. 3 illustrates an example method 300 for validating data across multiple data stores. As an example, the method 300 may relate to a client (e.g., local component) operating an OS that is capable to run applications or services. Method 300 may be executable on any device having at least one processor and also include storage capabilities. A client device may include processing means configured to execute operations of method 300. As an example, method 300 may be a computer-implemented method. The method 300 may operate in background of a client OS as other processes are operating in the foreground of the client OS.

Flow begins at operation 302 where a client (e.g., local component) identifies data for validation. In one example, a data store of a local client may request validation of data and submit the data for validation to a data consistency component of client to perform validation. In another example, a data consistency component of a client may identify the data for validation. In various examples, performance of validation may be scheduled or un-scheduled. In one example, performance of validation may be initiated by a component of a data store, for instance, when a change occurs to data in a data store. As another example, the data consistency component may perform validation in association with a schedule to attempt to maintain consistency among data stores of the client.

Once data is identified for validation, validation may be performed on the identified data (operation 304). In some cases, a validation may be performed in the background of an OS of the client without requiring a user of the client to initiate or manage a validation. For example, a user of the client may be operating an application in the foreground of the OS while a validation occurs in the background of the OS. As an example, the data consistency component may provide a user of the client with notification that a validation is running. In performing validation, the data consistency component may send a query to a local data store (or data stores) requesting data to perform a validation. The query may include a request (or multiple requests) for data related to a validatable component. In response to receiving a query from the data consistency component, a data store (or data stores) of the client sends data from the data store to the data consistency expert for evaluation. In one example, performance of the validation may include execution of several sub-tests of validatable components. Performance of validation may comprise taking an array of validatable components and executing operations to validation each validatable component. In some examples, validation of each component of a validation does not need to occur at the same time. Operation 304 may include comparing, using knowledge data, maintained on the client, portions of data obtained from a plurality of data stores. The knowledge data used in performing a comparison may be data identifying relationships between portions of data obtained from the plurality of data stores.

Flow may then proceed to operation 306, where validation differences or inconsistencies are identified. The data consistency component may determine differentiations between data maintained by a data store and data maintained by the data consistency component or other data stores. Data is evaluated to determine various possible variations and causes of the variations. For each mismatch determined, a unique identifier is assigned. When a mismatch is identified with regard to data of a data store, an error may be generated for evaluation. The error generated identifies the unique identifier of the error for reporting purposes.

Once errors are detected, method 300 proceeds to operation 308 where the inconsistencies identified in any of the plurality of data stores are reported. As an example, inconsistencies may be reported to an administrative component such as a telemetry component 110, examples of which are described in FIGS. 1 and 2. Different types of data may be reported at operation 308. In one example, inconsistencies are reported using the unique identifier assigned to a generated error. Flow may then proceed to operation 310, where an inconsistency may be remediated or repaired. Error remediation may occur manually or in an automated fashion. An administrative component that receives error information may evaluate the inconsistency to identify corrective measures for fixing the inconsistency as well as preventative measures to determine how to prevent inconsistencies from occurring in the future. In repairing identified errors, the client, via the consistency component, may take action to correct the error. In other examples, the client may receive repair instructions from the administrative component. Alternatively, an administrator may take administrative action on the client to repair an inconsistency/error.

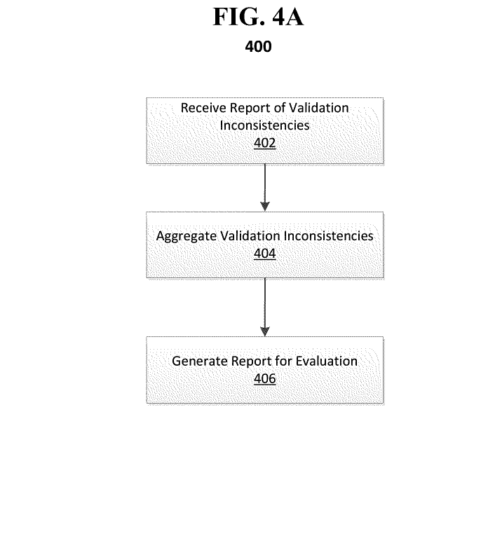

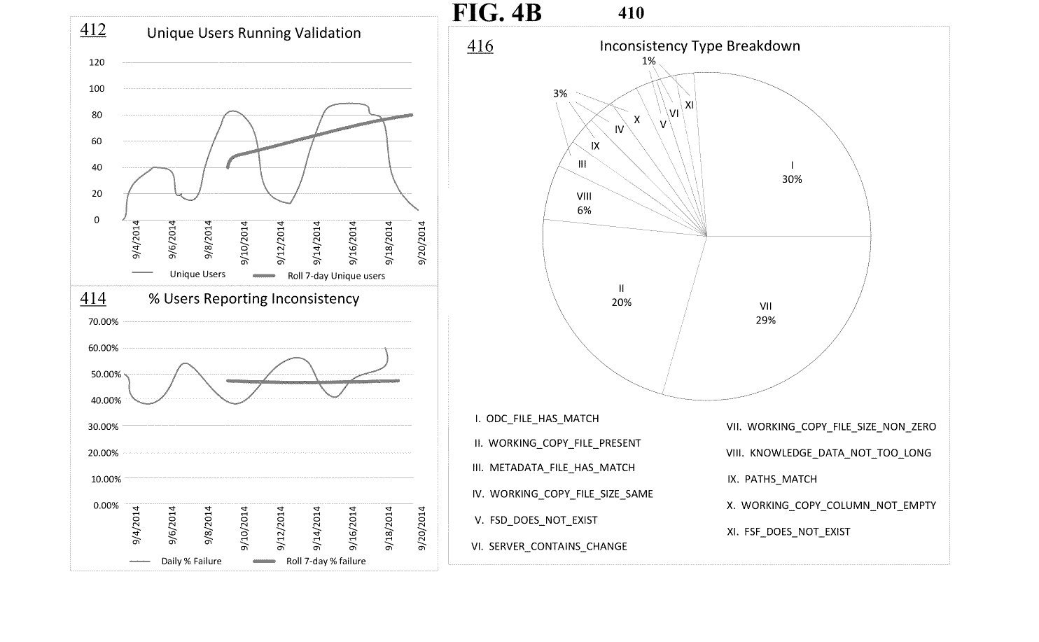

FIG. 4A illustrates a method 400 for reporting validation issues. As an example, the method 400 may relate to a component of a system that is configurable to monitor and report on validation results. An exemplary component to perform or execute method 400 may be the telemetry component 110 as described in FIG. 1. The telemetry component may be a device having processing and storage capabilities. The telemetry component may include processing means configured to execute operations of method 400. As an example, method 400 may be a computer-implemented method.

Flow begins at operation 402 where the telemetry component receives reporting of validation inconsistencies identified with respect to data stores of a client or local component. The data may be included in one or more reports. Inconsistencies may be identified by unique identifiers. Reporting of inconsistencies may be received by the telemetry component from a client or local component. As an example, reporting may be sent from a central authority of a client (e.g., data consistency expert/component), which identifies inconsistences existing with respect to data stores of the client. The telemetry component may implement an administrative tool or service that is used for presenting and evaluating inconsistency information. The administrative tool may be an application, service, or device running an application or service that is used to monitor functions related to validation and error detection. As an example, the administrative tool may be a dashboard application providing a real-time user interface showing presentations of current status and historical trends related to validation and error detection. The administrative tool may be connected to each and any component of a system and generate guiding metrics related to analysis performed on components of the system. Furthermore, the administrative tool may be modifiable and adaptable to collect and evaluate any type of information, for example related to tracking of validatable components and inconsistency detection. Among other things, the administrative tool may be usable to show summary data, key trends, comparisons, exceptions, etc.

Once an inconsistency reporting is received by the telemetry component, flow proceeds to operation 404 where the administrative reporting tool aggregates inconsistency information received from the client. In one example, data reported by the client (e.g., local component) may be aggregated with data received from other clients (e.g., local components) across a network. Statistical analysis may be performed on the combined data to form accumulated data. As an example, the administrative tool may form or group the different inconsistencies into groups or clusters. In other examples, the administrative tool may perform statistical analysis on inconsistency information, general information related to a client of a network or any other information related to performance of validation.

Once the inconsistency information is aggregated, the administrative tool may generate a report for the aggregated inconsistency information (operation 406). The report may be a validation report highlighting summary of empirical data for validatable components. In one example, the report generated may include graphical representations of data displayed through a user interface. As an example, the generated report may be a report based on the accumulated data including data on validation executed on local components of the network and data on inconsistencies identified across the local components of the network.

The administrative tool may further generate health metric information relating to analysis of validation and error information aggregated by the administrative tool. Health metric data may be data used by an administrator and/or end user to provide information that is used for both evaluation and repair of inconsistencies identified. Health metric data is not solely related to elements that are immediately visible to an end user, but may be used by administrators to identify and evaluate inconsistencies before such issues manifest to an end user. However, in some examples, an end user may be able to receive health metric data so that the user is informed and may take proactive steps to minimize inconsistencies.

FIG. 4B illustrates an example of a report 410 generated with respect to validation results. The report 410 may be a collection of metric data displayed through a user interface of a monitoring application. In one example, the report 410 may include aggregated or accumulated data of local components or clients of a network. As examples, administrators may use such information to assess performance of validation, inconsistencies identified across a network, or information pertaining to a particular local component or client. As an example, the report 410 may be displayed on a single page in a dashboard view of the monitoring application. However, in other examples, multiple pages of display may be available to a user of the monitoring application. A component including at least a processing processor may be used to generate the report 410. The processor may be configured to process, aggregate and display metric data.

Metric data displayed in the report 410 may be any telemetered condition information. Examples of metric data aggregated and displayed in the report 410 include information related to validations performed on client components. One or more groupings of metric data may be displayed in the report via a user interface. As shown in exemplary report 410, metric data may include information on unique users running validation (block 412), percent (%) of users reporting inconsistency (block 414), and inconsistency type breakdown (block 416), among other examples. Each of blocks 412, 414 and 416, respectively, may be illustrated in a graphical representation. Data may be compiled and displayed for one or more users (clients) of a system or network. Users of administrators of the monitoring application may selectively configure the monitoring application for report generation. The information on unique users running validation (block 412) is aggregated data on users (e.g., of client devices) that have or are currently performing validation. As an example, data may be aggregated for block 412 over a predetermined period of time as shown in report 410. The information on percent (%) of users reporting inconsistency (block 414) is aggregated data on local client components of users (e.g., of client devices) that an inconsistency was identified on. As an example, data may be aggregated for block 414 over a predetermined period of time as shown in report 410. The information on inconsistency type breakdown (block 416) is aggregated data on types of inconsistencies identified on local client components of users (e.g., of client devices). As an example, data of block 416 may be broken down by unique identifiers for inconsistencies identified across clients of a system or network.

FIGS. 5-7 and the associated descriptions provide a discussion of a variety of operating environments in which examples of the invention may be practiced. However, the devices and systems illustrated and discussed with respect to FIGS. 5-7 are for purposes of example and illustration and are not limiting of a vast number of computing device configurations that may be utilized for practicing examples of the invention, described herein.

FIG. 5 is a block diagram illustrating physical components of a computing device 502, for example a client, a data store, a data consistency expert component, a central knowledge component or a telemetry component, as described herein, with which examples of the present disclosure may be practiced. The computing device components described below may be suitable for the computing devices described above. In a basic configuration, the computing device 502 may include at least one processing unit 504 and a system memory 506. Depending on the configuration and type of computing device, the system memory 506 may comprise, but is not limited to, volatile storage (e.g., random access memory), non-volatile storage (e.g., read-only memory), flash memory, or any combination of such memories. The system memory 506 may include an operating system 507 and one or more program modules 508 suitable for running software applications 520 such as IO manager 524, other utility 526 and applications 528. The operating system 507, for example, may be suitable for controlling the operation of the computing device 502. Furthermore, examples of the invention may be practiced in conjunction with a graphics library, other operating systems, or any other application program and is not limited to any particular application or system. This basic configuration is illustrated in FIG. 5 by those components within a dashed line 522. The computing device 502 may have additional features or functionality. For example, the computing device 502 may also include additional data storage devices (removable and/or non-removable) such as, for example, magnetic disks, optical disks, or tape. Such additional storage is illustrated in FIG. 5 by a removable storage device 509 and a non-removable storage device 510.

As stated above, a number of program modules and data files may be stored in the system memory 506. While executing on the processing unit 504, the program modules 508 (e.g., virtual file system 108, Input/Output (I/O) manager 524, and other utility 526) may perform processes including, but not limited to, one or more of the stages of the operational flows illustrated in FIGS. 3 and 4A, for example. Other program modules that may be used in accordance with examples of the present invention may include electronic mail and contacts applications, word processing applications, spreadsheet applications, database applications, slide presentation applications, drawing or computer-aided application programs, etc.

Furthermore, examples of the invention may be practiced in an electrical circuit comprising discrete electronic elements, packaged or integrated electronic chips containing logic gates, a circuit utilizing a microprocessor, or on a single chip containing electronic elements or microprocessors. For example, examples of the invention may be practiced via a system-on-a-chip (SOC) where each or many of the components illustrated in FIG. 5 may be integrated onto a single integrated circuit. Such an SOC device may include one or more processing units, graphics units, communications units, system virtualization units and various application functionality all of which are integrated (or “burned”) onto the chip substrate as a single integrated circuit. When operating via an SOC, the functionality described herein may be operated via application-specific logic integrated with other components of the computing device 502 on the single integrated circuit (chip). Examples of the present disclosure may also be practiced using other technologies capable of performing logical operations such as, for example, AND, OR, and NOT, including but not limited to mechanical, optical, fluidic, and quantum technologies. In addition, examples of the invention may be practiced within a general purpose computer or in any other circuits or systems.

The computing device 502 may also have one or more input device(s) 512 such as a keyboard, a mouse, a pen, a sound input device, a touch input device, etc. The output device(s) 514 such as a display, speakers, a printer, etc. may also be included. The aforementioned devices are examples and others may be used. The computing device 504 may include one or more communication connections 516 allowing communications with other computing devices 518. Examples of suitable communication connections 516 include, but are not limited to, RF transmitter, receiver, and/or transceiver circuitry; universal serial bus (USB), parallel, and/or serial ports.

The term computer readable media as used herein may include computer storage media. Computer storage media may include volatile and nonvolatile, removable and non-removable media implemented in any method or technology for storage of information, such as computer readable instructions, data structures, or program modules. The system memory 506, the removable storage device 509, and the non-removable storage device 510 are all computer storage media examples (i.e., memory storage.) Computer storage media may include RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other article of manufacture which can be used to store information and which can be accessed by the computing device 502. Any such computer storage media may be part of the computing device 502. Computer storage media does not include a carrier wave or other propagated or modulated data signal.

Communication media may be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media.

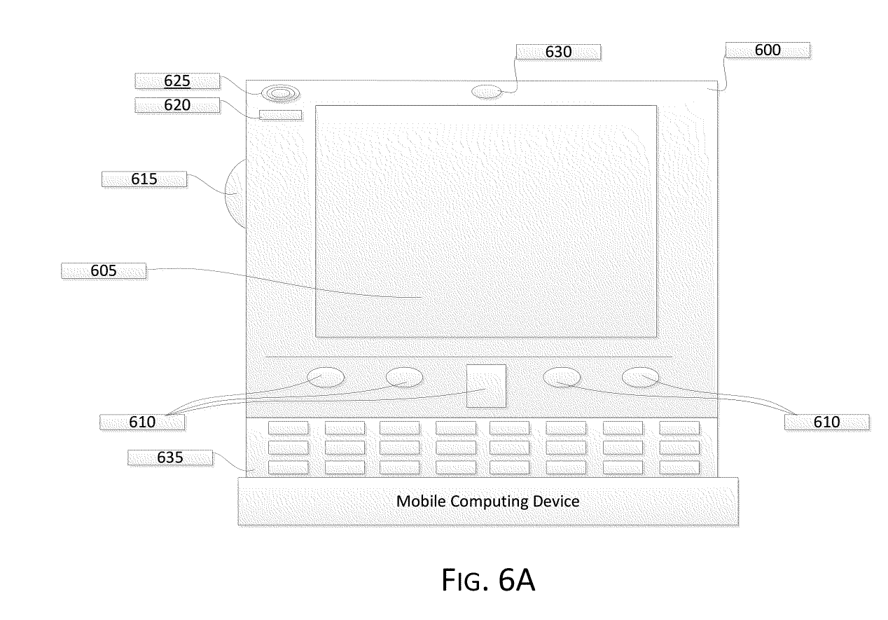

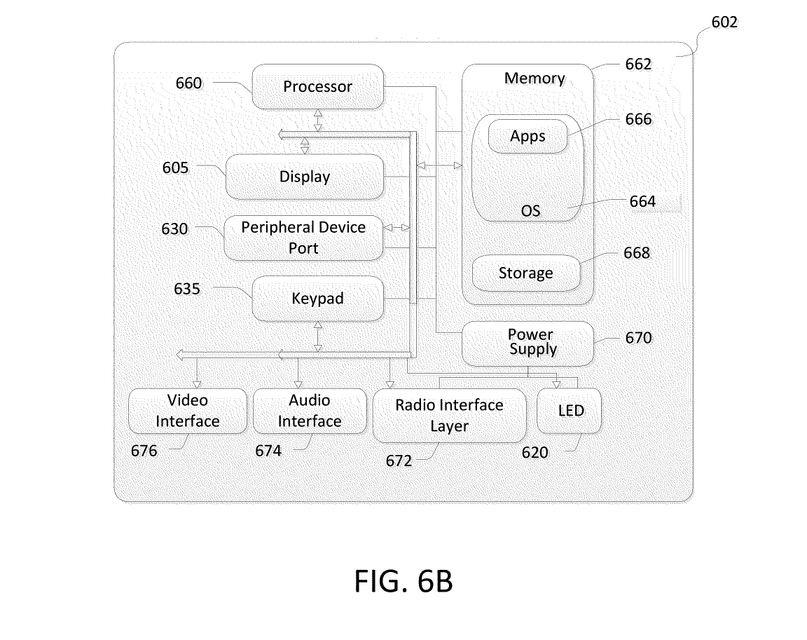

FIGS. 6A and 6B illustrate a mobile computing device 600, for example, a mobile telephone, a smart phone, a tablet personal computer, a laptop computer, and the like, with which examples of the invention may be practiced. For example, mobile computing device 600 may be used to implement a client, a data store, a data consistency expert component, a central knowledge component or a telemetry component, as examples. With reference to FIG. 6A, one example of a mobile computing device 600 for implementing the examples is illustrated. In a basic configuration, the mobile computing device 600 is a handheld computer having both input elements and output elements. The mobile computing device 600 typically includes a display 605 and one or more input buttons 610 that allow the user to enter information into the mobile computing device 600. The display 605 of the mobile computing device 600 may also function as an input device (e.g., a touch screen display). If included, an optional side input element 615 allows further user input. The side input element 615 may be a rotary switch, a button, or any other type of manual input element. In alternative examples, mobile computing device 600 may incorporate more or less input elements. For example, the display 605 may not be a touch screen in some examples. In yet another alternative example, the mobile computing device 600 is a portable phone system, such as a cellular phone. The mobile computing device 600 may also include an optional keypad 635. Optional keypad 635 may be a physical keypad or a “soft” keypad generated on the touch screen display. In various examples, the output elements include the display 605 for showing a graphical user interface (GUI), a visual indicator 620 (e.g., a light emitting diode), and/or an audio transducer 625 (e.g., a speaker). In some examples, the mobile computing device 600 incorporates a vibration transducer for providing the user with tactile feedback. In yet another example, the mobile computing device 600 incorporates input and/or output ports, such as an audio input (e.g., a microphone jack), an audio output (e.g., a headphone jack), and a video output (e.g., a HDMI port) for sending signals to or receiving signals from an external device.

FIG. 6B is a block diagram illustrating the architecture of one example of a mobile computing device. That is, the mobile computing device 600 can incorporate a system (i.e., an architecture) 602 to implement some examples. In one examples, the system 602 is implemented as a “smart phone” capable of running one or more applications (e.g., browser, e-mail, calendaring, contact managers, messaging clients, games, and media clients/players). In some examples, the system 602 is integrated as a computing device, such as an integrated personal digital assistant (PDA) and wireless phone.

One or more application programs 666 may be loaded into the memory 662 and run on or in association with the operating system 664. Examples of the application programs include phone dialer programs, e-mail programs, personal information management (PIM) programs, word processing programs, spreadsheet programs, Internet browser programs, messaging programs, and so forth. The system 602 also includes a non-volatile storage area 668 within the memory 662. The non-volatile storage area 668 may be used to store persistent information that should not be lost if the system 602 is powered down. The application programs 666 may use and store information in the non-volatile storage area 668, such as e-mail or other messages used by an e-mail application, and the like. A synchronization application (not shown) also resides on the system 602 and is programmed to interact with a corresponding synchronization application resident on a host computer to keep the information stored in the non-volatile storage area 668 synchronized with corresponding information stored at the host computer. As should be appreciated, other applications may be loaded into the memory 662 and run on the mobile computing device 600, including IO manager 524, other utility 526 and applications 528 described herein.

The system 602 has a power supply 670, which may be implemented as one or more batteries. The power supply 670 might further include an external power source, such as an AC adapter or a powered docking cradle that supplements or recharges the batteries.

The system 602 may include peripheral device port 678 that performs the function of facilitating connectivity between system 602 and one or more peripheral devices. Transmissions to and from the peripheral device port 672 are conducted under control of the operating system 664. In other words, communications received by the peripheral device port 678 may be disseminated to the application programs 666 via the operating system 664, and vice versa.

The system 602 may also include a radio 672 that performs the function of transmitting and receiving radio frequency communications. The radio 672 facilitates wireless connectivity between the system 602 and the “outside world,” via a communications carrier or service provider. Transmissions to and from the radio 672 are conducted under control of the operating system 664. In other words, communications received by the radio 672 may be disseminated to the application programs 666 via the operating system 664, and vice versa.

The visual indicator 620 may be used to provide visual notifications, and/or an audio interface 674 may be used for producing audible notifications via the audio transducer 625. In the illustrated example, the visual indicator 620 is a light emitting diode (LED) and the audio transducer 625 is a speaker. These devices may be directly coupled to the power supply 670 so that when activated, they remain on for a duration dictated by the notification mechanism even though the processor 660 and other components might shut down for conserving battery power. The LED may be programmed to remain on indefinitely until the user takes action to indicate the powered-on status of the device. The audio interface 674 is used to provide audible signals to and receive audible signals from the user. For example, in addition to being coupled to the audio transducer 625, the audio interface 674 may also be coupled to a microphone to receive audible input, such as to facilitate a telephone conversation. In accordance with examples of the present invention, the microphone may also serve as an audio sensor to facilitate control of notifications, as will be described below. The system 602 may further include a video interface 676 that enables an operation of an on-board camera 630 to record still images, video stream, and the like.

A mobile computing device 600 implementing the system 602 may have additional features or functionality. For example, the mobile computing device 600 may also include additional data storage devices (removable and/or non-removable) such as, magnetic disks, optical disks, or tape. Such additional storage is illustrated in FIG. 6B by the non-volatile storage area 668.

Data/information generated or captured by the mobile computing device 600 and stored via the system 602 may be stored locally on the mobile computing device 600, as described above, or the data may be stored on any number of storage media that may be accessed by the device via the radio 672 or via a wired connection between the mobile computing device 600 and a separate computing device associated with the mobile computing device 600, for example, a server computer in a distributed computing network, such as the Internet. As should be appreciated such data/information may be accessed via the mobile computing device 600 via the radio 672 or via a distributed computing network. Similarly, such data/information may be readily transferred between computing devices for storage and use according to well-known data/information transfer and storage means, including electronic mail and collaborative data/information sharing systems.

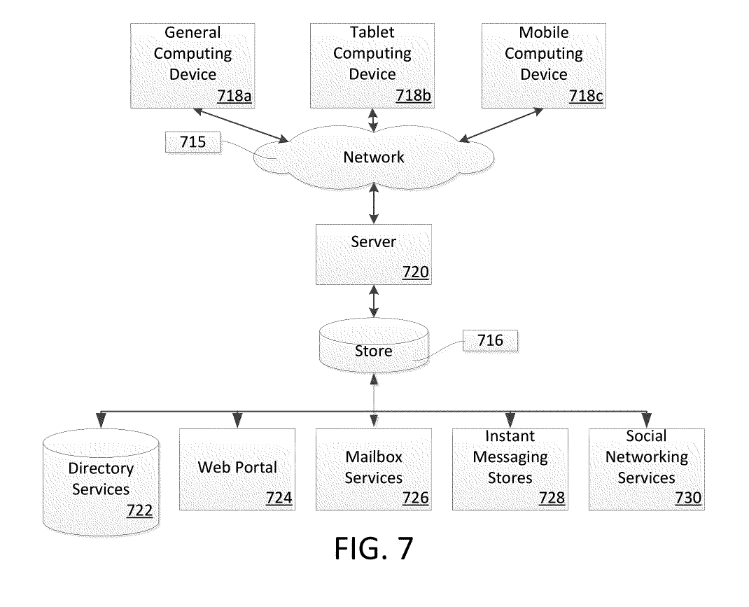

FIG. 7 illustrates one example of the architecture of a system for providing an application that reliably accesses target data on a storage system and handles communication failures to one or more client devices, as described above. Target data accessed, interacted with, or edited in association with IO manager 524, other utility 526, and applications 528 (e.g., program/module for data consistency expert 107 and data consistency component 202) may be stored in different communication channels or other storage types. For example, various documents may be stored using a directory service 722, a web portal 724, a mailbox service 726, an instant messaging store 728, or a social networking site 730, virtual file system 108, IO manager 524, other utility 526, and storage systems may use any of these types of systems or the like for enabling data utilization, as described herein. A server 720 may provide storage system for use by a client operating on general computing device 502 and mobile device(s) 600 through network 715. By way of example, network 715 may comprise the Internet or any other type of local or wide area network, and client nodes may be implemented as a computing device 502 embodied in a personal computer, a tablet computing device, and/or by a mobile computing device 600 (e.g., a smart phone). Any of these examples of the client computing device 502 or 600 may obtain content from the store 716.

In a non-limiting examples systems, computer-implemented methods and computer-readable storage devices are implemented to validate data across a plurality of data stores of a local device or client. In examples, a plurality of data stores of a client are queried by a data consistency component maintained on the client, to identify a portion of data from each of the plurality of data stores. Validation is performed on the portions of data by comparing the portions of data from the plurality of data stores using knowledge data maintained by the local device or client. Inconsistency is identified across the plurality of data stores based on the comparing of the portions of data. Inconsistency identified in any of the plurality of data stores is reported. In one example, the querying further comprises identifying, using the knowledge data, a portion of data in a first data store of the plurality of data stores that is associated with a portion of data in each of the other data stores of the plurality of data stores. The comparing compares the portion of data in the first data store with one or more portions of data in the other data stores that are associated to identify inconsistency between the portions of data of the plurality of data stores. In one example, the comparing further comprises comparing each of the portions of data from the plurality of data stores that are associated against data maintained by the data consistency component to identify inconsistency in data maintained in any of the plurality of data stores. For instance, the comparing of the portions of data further comprises comparing at least two data stores of the plurality of data stores having subsets of metadata for a file to determine if metadata from the at least two data stores matches, and identifying inconsistency when the subsets of metadata do not match. In yet another example, comparing further comprises comparing a whole file of a first data store and a whole file of a second data store to determine if a same whole file is represented in the at least two data stores to identify inconsistency when whole files of at least the first data store and at least the second data store do not match. When inconsistency is identified in one or more portions of data of the plurality of data stores, the inconsistency is remediated.

Reference has been made throughout this specification to “one example” or “an example,” meaning that a particular described feature, structure, or characteristic is included in at least one example. Thus, usage of such phrases may refer to more than just one example. Furthermore, the described features, structures, or characteristics may be combined in any suitable manner in one or more examples.

One skilled in the relevant art may recognize, however, that the examples may be practiced without one or more of the specific details, or with other methods, resources, materials, etc. In other instances, well known structures, resources, or operations have not been shown or described in detail merely to observe obscuring aspects of the examples.

While sample examples and applications have been illustrated and described, it is to be understood that the examples are not limited to the precise configuration and resources described above. Various modifications, changes, and variations apparent to those skilled in the art may be made in the arrangement, operation, and details of the methods and systems disclosed herein without departing from the scope of the claimed examples.

1. A computer-implemented method comprising:
querying, by a data consistency component maintained on a client, a plurality of data stores of the client to identify a portion of data from each of the plurality of data stores;
comparing portions of data from the plurality of data stores using knowledge data maintained by the data consistency component;
identifying inconsistency across the plurality of data stores based on the comparing of the portions of data; and
reporting inconsistency identified in any of the plurality of data stores.

2. The computer-implemented method according to claim 1, wherein the querying further comprises identifying, using the knowledge data, a portion of data in a first data store of the plurality of data stores that is associated with a portion of data in each of the other data stores of the plurality of data stores.

3. The computer-implemented method according to claim 2, wherein the comparing compares the portion of data in the first data store with one or more portions of data in the other data stores that are associated to identify inconsistency between the portions of data of the plurality of data stores.

4. The computer-implemented method according to claim 2, wherein the comparing further comprises comparing each of the portions of data from the plurality of data stores that are associated against data maintained by the data consistency component to identify inconsistency in data maintained in any of the plurality of data stores.

5. The computer-implemented method according to claim 2, further comprising remediating inconsistency in one or more portions of data of the plurality of data stores when inconsistency is identified.

6. The computer-implemented method according to claim 1, wherein the comparing of the portions of data further comprises comparing at least two data stores of the plurality of data stores having subsets of metadata for a file to determine if metadata from the at least two data stores matches, and the identifying identifies inconsistency when the subsets of metadata do not match.

7. The computer-implemented method according to claim 6, wherein the comparing further comprises comparing a whole file of a first data store and a whole file of a second data store to determine if a same whole file is represented in the at least two data stores, and the identifying identifies inconsistency when whole files of the first data store and the second data store do not match.

8. A system comprising:
a local device including a memory and at least one processor connected with the memory, wherein the processor is configured to execute a process comprising:
querying, a plurality of data stores of the local device to identify a portion of data from each of the plurality of data stores,
performing validation of the portions of data by comparing the portions of data from the plurality of data stores using knowledge data maintained by the local device,
identifying inconsistency across data stores of the local component based on the performed validation, and
reporting any inconsistency identified by the performed validation.

9. The system according to claim 8, wherein the querying further comprises identifying, using the knowledge data, a portion of data in a first data store of the plurality of data stores that is associated with a portion of data in each of the other data stores of the plurality of data stores.

10. The system according to claim 9, wherein the comparing compares the portion of data in the first data store with one or more portions of data in the other data stores that are associated to identify inconsistency between the portions of data of the plurality of data stores.

11. The system according to claim 9, wherein the comparing further comprises comparing each of the portions of data from the plurality of data stores that are associated against data maintained by the local device to identify inconsistency in data maintained in any of the plurality of data stores.

12. The system according to claim 9, wherein the process executed by the processor further comprising remediating inconsistency in one or more portions of data of the plurality of data stores when inconsistency is identified.

13. The system according to claim 8, wherein the comparing of the portions of data further comprises comparing at least two data stores of the plurality of data stores having subsets of metadata for a file to determine if metadata from the at least two data stores matches, and the identifying identifies inconsistency when the subsets of metadata do not match.

14. The system according to claim 13, wherein the comparing further comprises comparing a whole file of a first data store and a whole file of a second data store to determine if a same whole file is represented in the at least two data stores, and the identifying identifies inconsistency when whole files of the first data store and the second data store do not match.

15. A computer-readable storage device including executable instructions, that when executed on at least one processor, causing the processor to perform a process comprising:
querying, by a data consistency component maintained on a client, a plurality of data stores of the client to identify a portion of data from each of the plurality of data stores;
comparing portions of data from the plurality of data stores using knowledge data maintained by the data consistency component;
identifying inconsistency across the plurality of data stores based on the comparing of the portions of data; and
reporting inconsistency identified in any of the plurality of data stores.

16. The computer-readable storage device according to claim 15, wherein the querying executed by the processor further comprises identifying, using the knowledge data, a portion of data in a first data store of the plurality of data stores that is associated with a portion of data in each of the other data stores of the plurality of data stores.

17. The computer-readable storage device according to claim 16, wherein the comparing executed by the processor further comprises comparing the portion of data in the first data store with one or more portions of data in the other data stores that are associated to identify inconsistency between the portions of data of the plurality of data stores.

18. The computer-readable storage device according to claim 16, wherein the comparing executed by the processor further comprises comparing each of the portions of data from the plurality of data stores that are associated against data maintained by the data consistency component to identify inconsistency in data maintained in any of the plurality of data stores, and wherein the process further comprising remediating inconsistency in one or more portions of data of the plurality of data stores when inconsistency is identified.

19. The computer-readable storage device according to claim 15, wherein the comparing executed by the processor further comprises comparing at least two data stores of the plurality of data stores having subsets of metadata for a file to determine if metadata from the at least two data stores matches, and the identifying identifies inconsistency when the subsets of metadata do not match.

20. The computer-readable storage device according to claim 19, wherein the comparing executed by the processor further comprises comparing a whole file of a first data store and a whole file of a second data store to determine if a same whole file is represented in the at least two data stores, and the identifying identifies inconsistency when whole files of the first data store and the second data store do not match.
